(19) United States
(12) Patent Application Publication
(10) Pub. No.: US 2022/0395992 A1
(43) Pub. Date: Dec. 15, 2022

(54) Tile Nipper

(71) Applicant: Marshalltown Company, Marshalltown, IA (US)

(72) Inventors: John T. Hughes, Fayetteville, AR (US); Harrison S. Miller, Lowell, AR (US)

(21) Appl. No.: 17/807,072

(22) Filed: Jun. 15, 2022

Related U.S. Application Data
(60) Provisional application No. 63/210,977, filed on Jun. 15, 2021.

(51) Int. Cl. B26B 17/00; B28D 1/22; B28D 1/24

(52) U.S. Cl. CPC B26B 17/006; B28D 1/225; B28D 1/24

(57) ABSTRACT

A tile nipper includes an adjustable stop configured to adjust a maximum width of a jaw mouth imparted by a biasing spring. The spring may be an internal spring housed within one or more arms of the tile nipper.

### CROSS-REFERENCE TO RELATED APPLICATION

The present application claims the benefit of U.S. Provisional Application Ser. No. 63/210,977, filed Jun. 15, 2021, the entirety of which is hereby incorporated by reference.

### FIELD OF THE DISCLOSURE

The present disclosure generally relates to tile nippers.

### BACKGROUND OF THE DISCLOSURE

A tile nipper is a hand-held tool used to remove pieces from a tile to facilitate cutting along a curved line, for example. Tile nippers may be used, for example, on ceramic, porcelain, or glass tiles.

### SUMMARY

In one aspect, a tile nipper generally comprises first and second arms rotatably coupled to one another. The first arm includes a first nipper jaw. The second arm includes a second nipper jaw generally opposing the first nipper jaw to define a jaw mouth therebetween having a width. A spring applies a rotational force to the first and second arms to bias the first and second nipper jaws in an opened configuration in which the jaw mouth has a maximum width for receiving material to be cut by the tile nipper. An adjustable stop is configured to adjust the maximum width of the jaw mouth imparted by the spring.

In another aspect, a tile nipper generally comprises first and second arms rotatably coupled to one another. The first arm includes a first nipper jaw. The second arm includes a second nipper jaw generally opposing the first nipper jaw to define a jaw mouth therebetween having a width. A spring applies a rotational force to the first and second arms to bias the first and second nipper jaws in an opened configuration in which the jaw mouth has a maximum width for receiving material to be cut by the tile nipper. The spring is internal and housed within one or both of the first and second arms.

### BRIEF DESCRIPTION OF THE DRAWINGS

FIG. 1 is a perspective of a tile nipper including nipper jaws in a fully closed configuration and an adjustable stop in a fully closed angular position.

FIG. 2 is a front elevation of the tile nipper.

FIG. 3 is an enlarged, fragmentary elevation of the tile nipper.

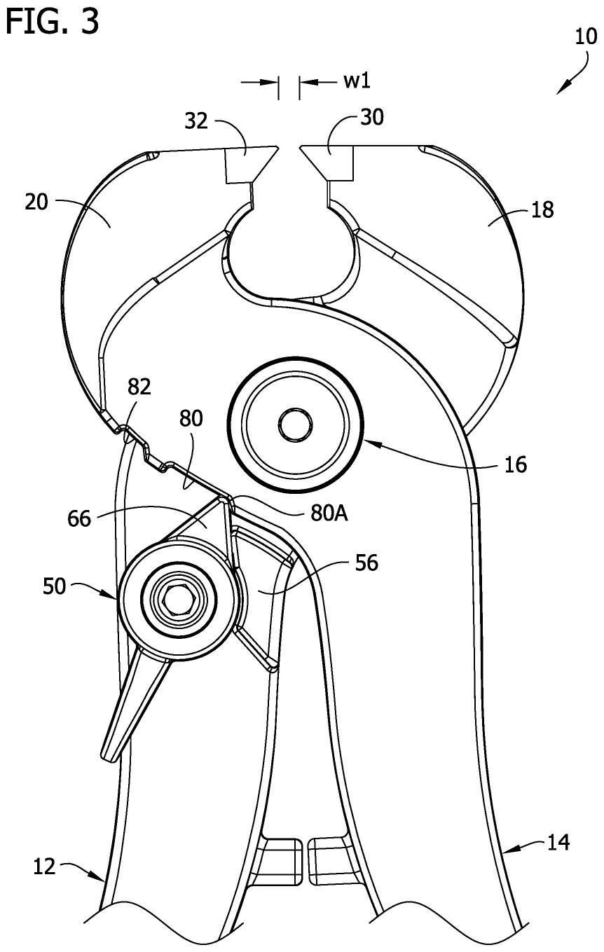

FIG. 4 is a partial exploded view of the tile nipper.

FIG. 5 is a partial exploded view of the tile nipper.

FIG. 6 is a front elevation of the tile nipper showing the nipper jaws in a first partially opened configuration and the adjustable stop in a first partially open angular position.

FIG. 7 is a front elevation of the tile nipper showing the nipper jaws in a second partially opened configuration and the adjustable stop in a second partially open angular position.

FIG. 8 is a front elevation of the tile nipper showing the nipper jaws in a fully opened configuration and the adjustable stop in a fully open angular position.

FIG. 9 is a perspective of another embodiment of a tile nipper similar to the first tile nipper other than cutters of the nipper jaws being of a second type.

FIG. 10 is a perspective of another embodiment of a tile nipper similar to the first tile nipper other than the nipper jaws being of a third type.

FIG. 11 is a perspective of another embodiment of a tile nipper similar to the first tile nipper other than the nipper jaws being of a fourth type.

### DETAILED DESCRIPTION OF THE DISCLOSURE

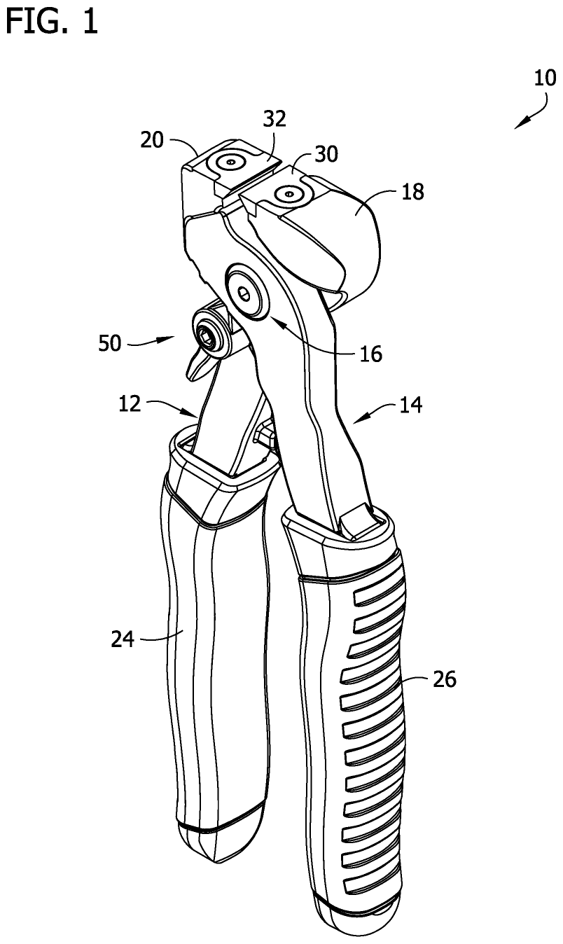

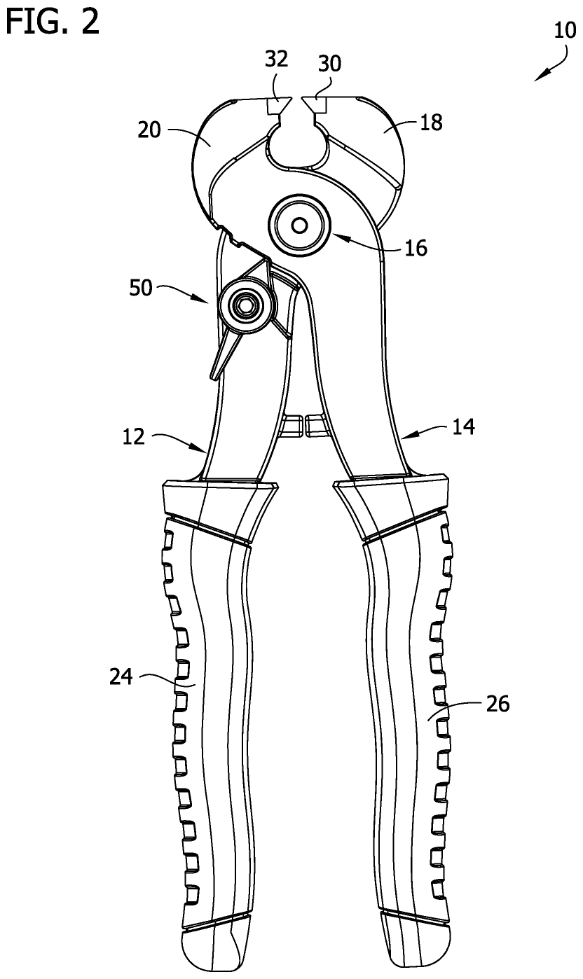

Referring to FIGS. 1-2, a first embodiment of a tile nipper is generally indicated at reference numeral 10. In general, the tile nipper 10 is hand-held and configured to nip, bite, cut, score, and/or break tile for purposes of shaping the tile, for example. The tile nipper 10 includes a first and second arms, generally indicated at 12, 14, respectively, rotatably connected to one another by a pin, generally indicated at 16, or other rotatable coupler. Each of the first and second arms 12, 14 includes a nipper jaw 18, 20, respectively, adjacent a first end of the corresponding arm, and a handle 24, 26, respectively, adjacent a second end of the corresponding arm such that the nipper jaws and the handles are on opposite sides of the pin 16. The respective handles 24, 26 include grips, which may be rubber or other material suitable, for gripping.

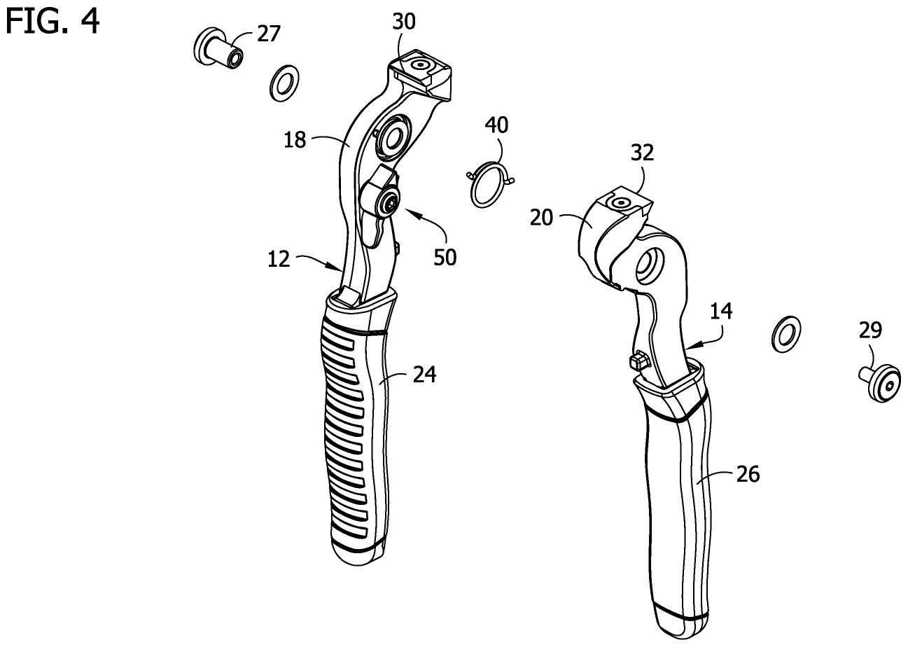

Referring to FIG. 4, the illustrated pin 16 is a coupler assembly including a plain bearing 27 (e.g., bushing) fastened to the first and second arms 12, 14 by a fastener 29.

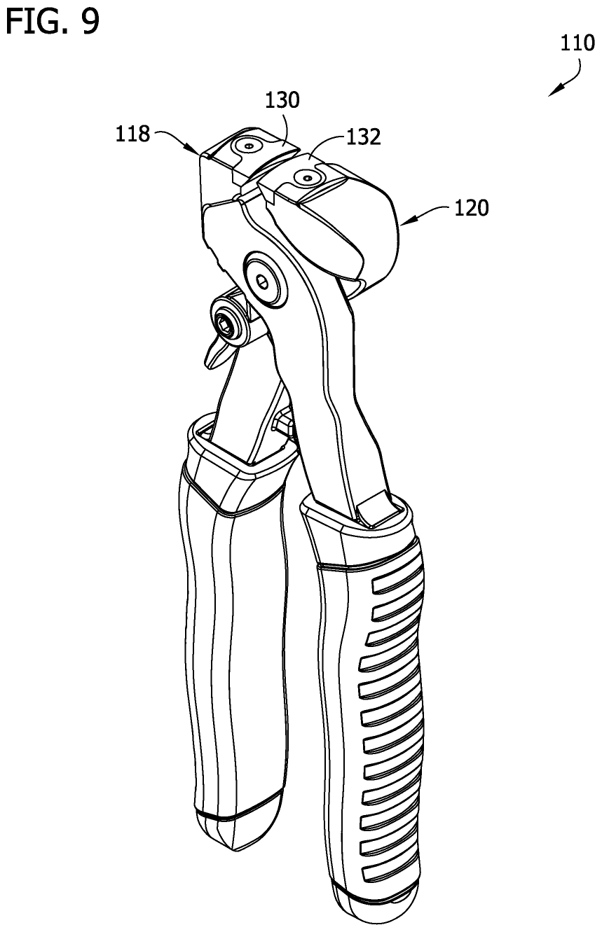

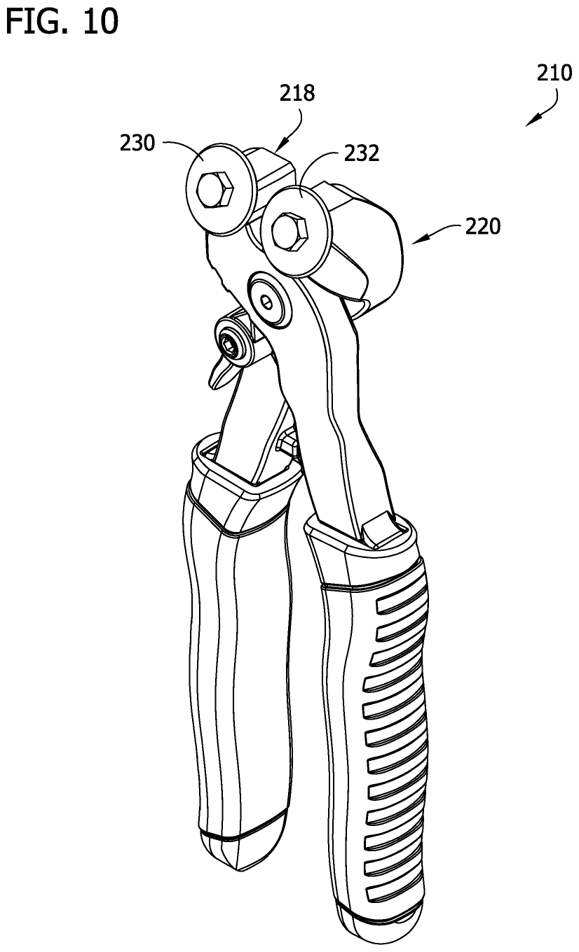

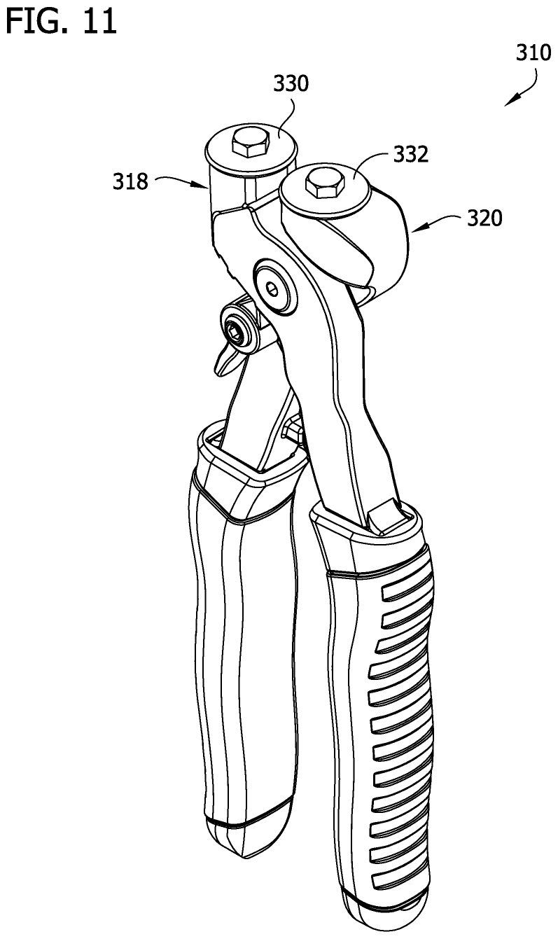

The jaws 18, 20 include blades 30, 32 which generally oppose one another to define an opening or mouth for receiving a piece of tile. The distance between edges of the blades 30, 32 defines a width of the opening. Squeezing the handles 24, 26 toward one another moves the blades 30, 32 toward one another and toward a closed configuration at which the width of the opening is at its minimum. The closed configuration is shown in FIGS. 1 and 2. Moving the handles 24, 26 away from one another moves the blades 30, 32 away from one another toward a fully open configuration, at which the width of the opening is at its maximum. As explained below, the blades 30, 32 are movable to positions between the fully closed and fully opened configurations. The illustrated blades 30, 32 are straight edge blades. The tile nipper may include other types of jaws and/or blades in other embodiments. For example, in FIG. 9 a tile nipper 110 includes jaws 118, 120 with arcuate edge blades 130, 132; in FIG. 10 a tile nipper 210 includes jaws 218, 220 with circular blades 230, 232 angled on sides of the jaws; and in FIG. 11 a tile nipper 310 includes jaws 318, 320 with circular blades 330, 332 on upper portions of the jaws. Other designs and constructions are possible.

Referring to FIG. 4, in the illustrated embodiment, the blades 30, 32 are biased toward the fully opened configuration by a spring 40 or other resilient element disposed within one or both of the arms 12, 14. Thus, the spring 40 is an internal spring (e.g., hidden) housed within one or both of the arms 12, 14 and disposed between the two arms. The illustrated spring 40 is a torsion spring that surrounds the pin 16 and applies a rotational force (or torque) to the arms 12, 14. The rotational force of the spring 40 is overcome when squeezing the handle 24, 26, and when the squeezing force is removed or suitably reduced, the spring force moves the arms 12, 14 to move the blades 30, 32 away from one another.

The illustrated tile nipper 10 further includes an adjustable jaw stop, generally indicated at 50, configured to enable a user to selective restrict the maximum degree or amount to which the jaws 18, 20 open (i.e., a maximum width of the mouth) due to the biasing force of the spring 40. That is, the adjustable stop 50 is configured to restrict the mouth opening between the two blades 30, 32 imparted by the biasing force of the spring 40. In accordance with the present disclosure relating to the adjustable jaw stop 50, it is understood that the adjustable jaw stop enables the user to selectively restrict opening of the jaws to at least one partially opened configuration that is between the opened and fully closed configurations. The fully opened and fully closed configurations may be controlled by one or more other stops or through construction of the tile nipper 10.

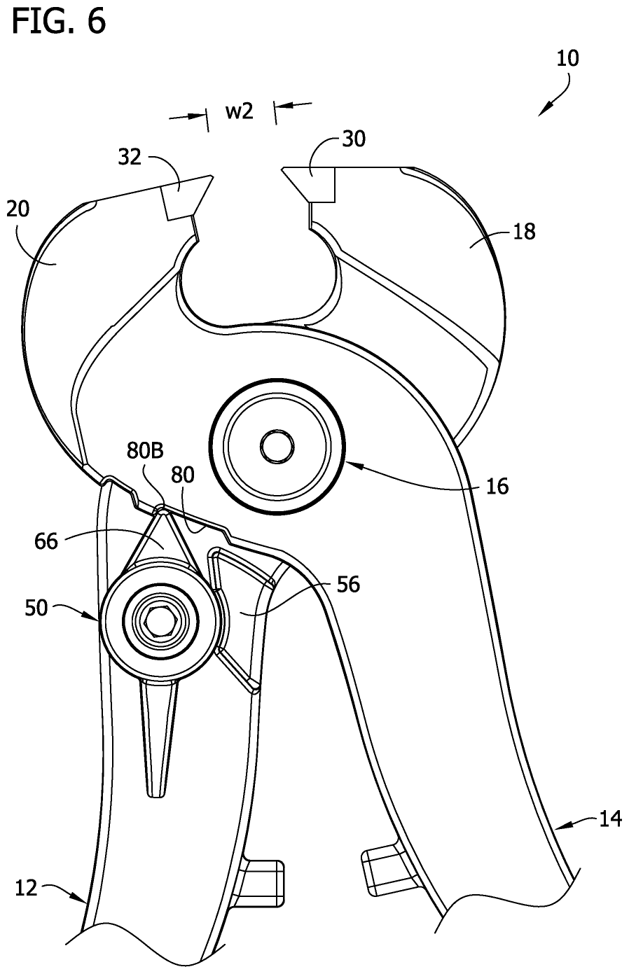

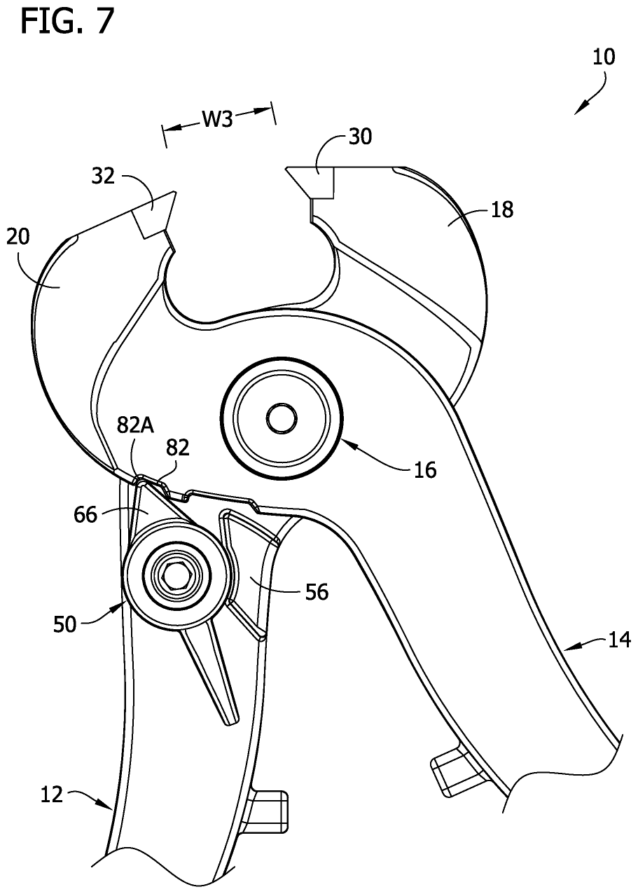

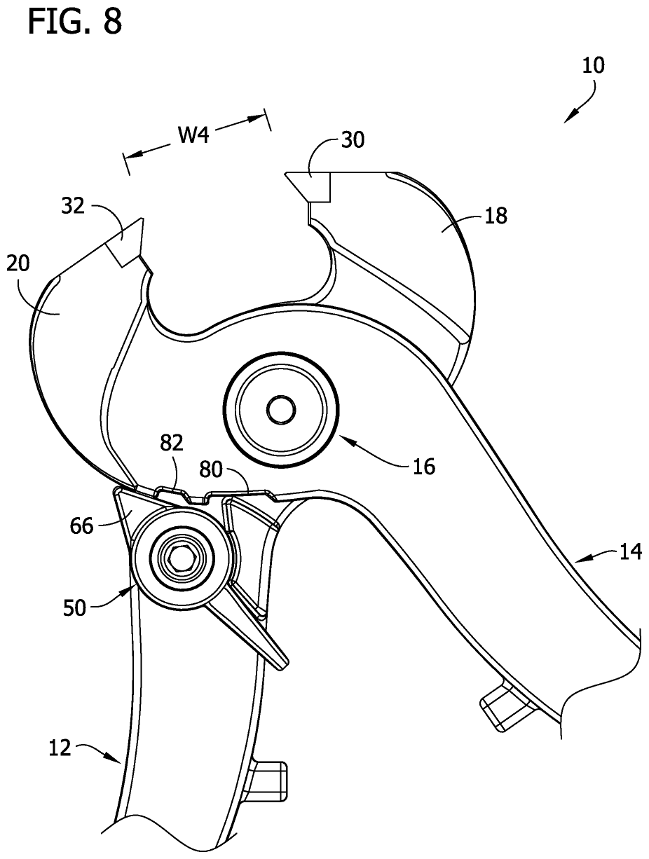

In the illustrated embodiment, the adjustable jaw stop 50 is configured to selectively i) lock tile nipper 10 in the fully closed configuration (as shown in FIGS. 1 and 2) to inhibit the tile nipper from being moved toward the opened configuration (in the illustrated embodiment the blades are spaced apart from one another in the fully closed configuration such that the mouth opening has a first (or minimum) width w1; ii) enable the tile nipper to open to a first partially opened configuration defining a first maximum width w2 of the mouth opening that is greater than the first width (FIG. 6); iii) enable the tile nipper to open to a second partially opened configuration defining a second maximum width w3 of the mouth opening that is greater than the first maximum width (FIG. 7); and iv) enable the tile nipper to open to a fully opened configuration defining a third maximum width w4 of the mouth opening that is greater than the second width (FIG. 8). In one example, the width w1 may measure from about 0 in to about 1/8 in, the maximum width w2 may measure about ¼ in, the maximum width w3 may measure about ½ or 3/8 in, and the maximum width w4 may be greater than ½ in or 3/8 in to about 1 in or greater. The mouth opening in the different configurations of the tile nipper 10 may have different pre-selected widths without departing from the scope of present disclosure.

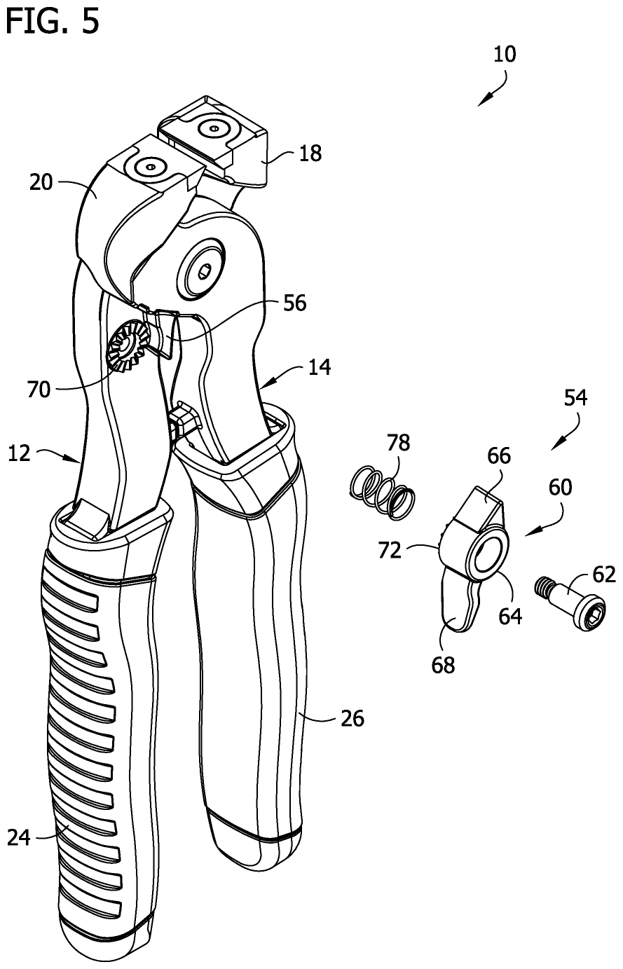

Referring to FIG. 5, the illustrated adjustable jaw stop 50 comprises a detent mechanism, generally indicated at 54, and a detent stop 56. The detent mechanism 50 includes a lever, generally indicated at 60, rotatable mounted on one of the arms (e.g., the first arm 12) by a pin 62 (e.g., a shoulder bolt). The lever 60 includes a body 64, a catch 66 extending radially outward from the body, and a wing 68 extending radially outward from the body generally diametrically opposite the catch. The pin 62 is received through an opening in the body 64 and threaded in the corresponding arm (e.g., the first arm 12) to allow rotation of the lever 60 about the pin. The corresponding arm (e.g., the first arm 12) and the lever 60 include sets of teeth 70, 72 that mesh or engage one another to selectively arrest rotational movement of the lever relative to the arm, for purposes explained in more detail below. Each of the illustrated sets of teeth 70, 72 are annular set of teeth, although the teeth may be arranged in other ways. A detent spring 78 (e.g., a tension spring) biases the teeth 70, 72 into meshing engagement. The teeth 70, 72 are arranged and configured such that the biasing force of the detent spring 78 can be overcome upon rotation of the lever 60 about the pin 62, such that the teeth 72 of the lever move out of initial gaps defined by the teeth 70 on the arm 12, ride up and over the adjacent teeth 70 on the arm 12, and then drop into gaps adjacent the initial gaps under the biasing force of the detent spring. This design and construction enables movement of the lever 60 to different pre-set angular positions on the arm 12, as defined by the spacing of the gaps between the teeth 70. The lever 60 is selectively rotatable clockwise and counterclockwise to enable movement in either direction against the force of the detent spring 78. The wing 68 may be pushed by a user's thumb to rotate the lever 60. It is understood that teeth 72 on the lever 60 may be considered pawls (there may be only one pawl) which engage a rack (e.g., arcuate or annular rack) having one or more teeth on the corresponding arm 12 to arrest rotational movement.

The catch 66 of the lever 60 is receivable in first and second notches 80, 82 on (e.g., defined by) the opposite arm (e.g., the second arm 14). It is understood that in other embodiments, there may be one notch or more than two notches (i.e., at least one notch).

To selectively lock the tile nipper 10 in the fully closed configuration (as shown in FIGS. 1 and 2), the lever 60 is rotatable to a first angular position in which the catch 66 is received in the first notch 80 and engages a first corner 80A of the first notch. In this angular position, the catch 66 inhibits the first and second arms 12, 14 from rotating relative to one another. This locking configuration is a safety feature. The detent stop 56 inhibits the lever 60 from being rotated beyond (e.g., in the clockwise direction) the first angular position. In the illustrated embodiment, the catch 66 engages the detent stop 56 to inhibit further rotation.

Referring to FIG. 6, to selectively enable the tile nipper 10 to open to the first partially opened configuration and no more, the lever 60 is rotated to a second angular configuration in which the catch 66 is received in the first notch 80 and engages a second corner 80B of the first notch when the tile nipper is opened to the first partially opened configuration. In this angular position, the catch 66 inhibits the first and second arms 12, 14 from further rotation beyond the first partially opened configuration while enabling the jaws 18, 20 to be fully closed. This configuration facilitates nipping of tile having a thickness slightly less than the width w2 of the mouth opening at the first partially opened configuration. In this configuration, to nip tile the user is not required to continuously squeeze the handles 24, 26 between the fully opened configuration and the fully closed configuration, but instead, only needs to squeeze the handles between the first partially opened configuration and the fully closed configuration. This reduces user fatigue and increases efficiency of the tile nipper 10.

Referring to FIG. 7, to selectively enable the tile nipper 10 to open to the second partially opened configuration and no more, the lever 60 is rotated to a third angular position in which the catch 66 is received in the second notch 82 and engages a corner 82A of the second notch when the tile nipper is opened to the second partially opened configuration. In this angular position, the catch 66 inhibits the first and second arms 12, 14 from further rotation beyond the second partially opened configuration while enabling the jaws 18, 20 to be fully closed. This configuration facilitates nipping of tile having a thickness slightly less than the width w3 of the mouth opening at the second partially opened configuration. In this configuration, to nip tile the user is not required to continuously squeeze the handles 24, 26 between the fully opened configuration and the fully closed configuration, but instead, only needs to squeeze the handles between the second partially opened configuration and the fully closed configuration. This reduces user fatigue and increases efficiency of the tile nipper 10.

Referring to FIG. 8, to selectively enable the tile nipper 10 to open to the fully opened configuration, the lever 60 is rotated (e.g., counterclockwise from the third angular position) to a fourth angular position in which the catch 66 is removed from the second notch 82. In this angular position, the catch 66 does not inhibit the first and second arms 12, 14 from rotating relative to one another. This configuration enables the user to fully open the nipper 10. The detent stop 56 inhibits the lever 60 from further rotating beyond (e.g., counterclockwise) the fourth angular position.

In the illustrated embodiment, the lever 60 is selectively rotatable to four different angular positions: the first, second, third, and fourth pre-selected angular positions described above. The lever 60 may be selectively rotatable to other angular positions. The teeth 70, 72 are configured provide auditory and/or tactile feedback to the user as the lever 60 is moved from one pre-selected angular position to another. In particular, the gaps between the teeth 70, 72 are such that each movement of teeth from initial teeth gaps to adjacent teeth gaps changes the angular position to the adjacent angular position and may provide an auditory “clicking” sound and a feel as the teeth enter the adjacent teeth gaps. The nipper 10 may include indicia indicating the size of the mouth opening at one or more of the pre-selected angular positons of the lever 60.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A tile nipper comprising:
first and second arms rotatably coupled to one another, wherein the first arm includes a first nipper jaw, and the second arm includes a second nipper jaw generally opposing the first nipper jaw to define a jaw mouth therebetween having a width,
a spring applying a rotational force to the first and second arms to bias the first and second nipper jaws in an opened configuration in which the jaw mouth has a maximum width for receiving material to be cut by the tile nipper; and
an adjustable stop configured to adjust the maximum width of the jaw mouth imparted by the spring.

2. The tile nipper set forth in claim 1, wherein the first jaw includes a first blade, and the second jaw includes a second blade, wherein the jaw mouth is defined by spacing between the first and second blades.

3. The tile nipper set forth in claim 2, wherein first and second blades each includes a straight edge blade.

4. The tile nipper set forth in claim 2, wherein first and second blades each includes an arcuate edge blade.

5. The tile nipper set forth in claim 2, wherein first and second blades each includes a circular edge blade.

6. The tile nipper set forth in claim 5, wherein the first blade is angled on a side of the first jaw, wherein the second blade is angled on a side of the second jaw.

7. The tile nipper set forth in claim 5, wherein the first blade is on an upper portion of the first jaw, wherein the second blade is on an upper portion of the second jaw.

8. The tile nipper set forth in claim 1, wherein the adjustable stop is further configured to lock the first and second nipper jaws in a fully closed position in which the jaw mouth has a minimum width.

9. The tile nipper set forth in claim 1, wherein the adjustable stop is configured to adjust the maximum width of the jaw mouth imparted by the spring between a first maximum width and second maximum width, wherein the second maximum width is greater than the first maximum width.

10. The tile nipper set forth in claim 9, wherein the first maximum width measures ¼ in (6.25 mm).

11. The tile nipper set forth in claim 10, wherein the second maximum width measures ½ in (12.7 mm) or 3/8 in (9.525 mm).

12. The tile nipper set forth in claim 9, wherein the adjustable stop is further configured to adjust the maximum width of the jaw mouth imparted by the spring to a third maximum width greater than the second maximum width.

13. The tile nipper set forth in claim 1, wherein the adjustable stop includes a detent mechanism.

14. The tile nipper set forth in claim 13, wherein the detent mechanism includes a lever rotatably mounted on the first arm.

15. The tile nipper set forth in claim 14, wherein the second arm defines first and second notches configured to selectively receive the lever therein to enable adjustment of the stop.

16. The tile nipper set forth in claim 14, wherein the detent mechanism further includes meshing teeth on the lever and the first arm to selectively arrest rotational movement of the lever relative to the first arm.

17. The tile nipper set forth in claim 16, wherein the detent mechanism further includes a biasing spring biasing the teeth in meshing engagement.

18. The tile nipper set forth in claim 1, wherein the spring is internal and housed within one or both of the first and second arms.

19. A tile nipper comprising:
first and second arms rotatably coupled to one another, wherein the first arm includes a first nipper jaw, and the second arm includes a second nipper jaw generally opposing the first nipper jaw to define a jaw mouth therebetween having a width,
a spring applying a rotational force to the first and second arms to bias the first and second nipper jaws in an opened configuration in which the jaw mouth has a maximum width for receiving material to be cut by the tile nipper, wherein the spring is internal and housed within one or both of the first and second arms.

20. The tile nipper set forth in claim 19, wherein the spring is a torsion spring.
